(19) United States
(12) Patent Application Publication
(10) Pub. No.: US 2026/0276878 A1
(43) Pub. Date: Sep. 17, 2026

(54) BACKLIGHT MODULE AND ELECTRONIC DEVICE HAVING THE SAME

(71) Applicants: ADVANCED OPTOELECTRONIC TECHNOLOGY, INC., Hsinchu County (TW); Asphetek Solution Inc., Hsinchu (TW); EXBRI TECHNOLOGY INC., Hsinchu City (TW)

(72) Inventors: CHAO-YUAN CHEN, Hsinchu (TW); CHUANG-YU HSIEH, Hsinchu (TW); HSIN-TING HUNG, Hsinchu (TW); HAO-HSIANG HSIEH, Hsinchu (TW); HUNG-CHIEH CHIN, Hsinchu (TW); CHENG-HONG JIANG, Hsinchu (TW); CHING-LIN LI, Hsinchu (TW)

(21) Appl. No.: 19/206,276

(22) Filed: May 13, 2025

(30) Foreign Application Priority Data
Mar. 12, 2025 (CN) 202510290952.X

(51) Int. Cl. F21V 8/00

(52) U.S. Cl. CPC G02B 6/0021; G02B 6/0016; G02B 6/0068

(57) ABSTRACT

A backlight module includes a substrate, a light guide plate and a plurality of light sources. The light guide plate includes a bottom surface, a top surface, and a plurality of receiving recesses. The bottom surface and the top surface are facing away from each other, and the bottom surface is closer to the substrate than to the top surface. The receiving recesses are recessed inward from the bottom surface. Each receiving recess includes a groove bottom surface and at least one light incident surface connected to the groove bottom surface, a normal direction of each of the light incident surface is not parallel to a normal direction of the bottom surface. The light sources are electrically connected to the substrate and arranged in the receiving recesses. Each light source is configured to emit light toward the light incident surface of one of the receiving recesses.

### FIELD

The subject matter herein generally relates to a light source device, and in particular to a backlight module and an electronic device having the backlight module.

### BACKGROUND

Generally, backlight modules are roughly divided into direct-type, edge-type and full-array types, wherein the edge-type backlight module uses a light-emitting diode that emits light from the side and a light guide plate to guide light into the display panel, while the direct-type and the full-array types emit light directly from the back.

However, the conventional direct-type, edge-type and full-array backlight modules cannot take into account thinness, low cost and excellent local backlight adjustment effect. In detail, the direct-type backlight module needs to be used with a lens, which makes the overall display thicker; the full-array type needs to be filled with light-emitting diodes throughout the backlight module, which has the disadvantage of high cost; the edge-type backlight module has a poor performance in the local backlight adjustment effect because the light-emitting diodes are arranged at the outermost edge.

Therefore, there is room for improvement within the art.

### BRIEF DESCRIPTION OF THE DRAWINGS

Implementations of the present disclosure will now be described, by way of embodiments, with reference to the attached figures.

FIG. 1 is a side schematic diagram of a display panel and a backlight module according to a first embodiment of the present application.

FIG. 2 is a top schematic diagram of a light guide plate, a light shielding structure and a light source of the backlight module in FIG. 1.

FIG. 3 is a partial enlarged view of the light guide plate and the light source in FIG. 2.

FIG. 4 is a partial enlarged view of a side schematic diagram of the light guide plate of the backlight module in FIG. 1 from another viewing angle.

FIG. 5 is a partial enlarged view of a top schematic diagram of a light guide plate and a light source according to a second embodiment of the present application.

FIG. 6 is a partial enlarged view of a top schematic diagram of a light guide plate according to a third embodiment of the present application.

FIG. 7 is a partial enlarged view of a top schematic diagram of a light guide plate according to a fourth embodiment of the present application.

FIG. 8 is a partial enlarged view of a top schematic diagram of a light guide plate according to a fifth embodiment of the present application.

FIG. 9 is a partial enlarged view of a top schematic diagram of a light guide plate according to a sixth embodiment of the present application.

FIG. 10 is a schematic diagram of an electronic device according to an embodiment of the present disclosure.

### DETAILED DESCRIPTION

It will be appreciated that for simplicity and clarity of illustration, where appropriate, reference numerals have been repeated among the different figures to indicate corresponding or analogous components. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale, and the proportions of certain parts may be exaggerated to better illustrate details and features of the present disclosure.

The disclosure is illustrated by way of example and not by way of limitation in the figures of the accompanying drawings, in which like references indicate similar components. It should be noted that references to “an” or “one” embodiment in this disclosure are not necessarily to the same embodiment, and such references mean “at least one.”

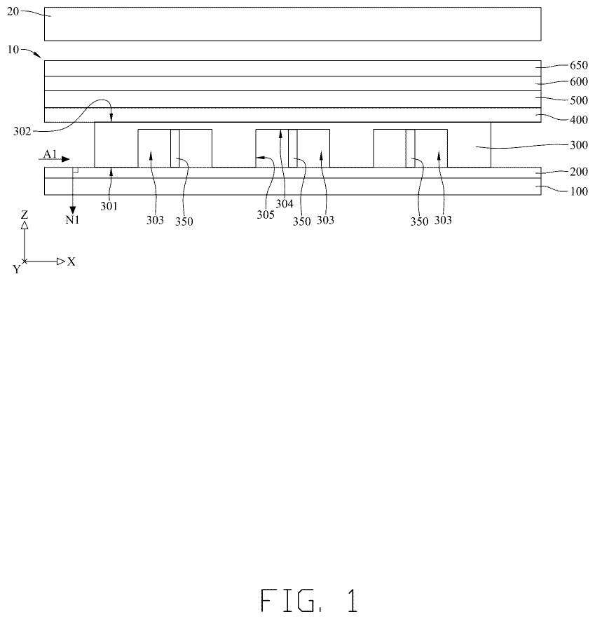

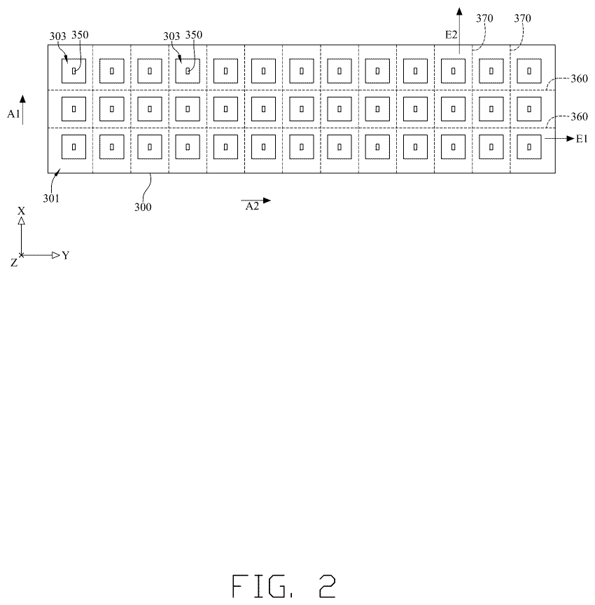

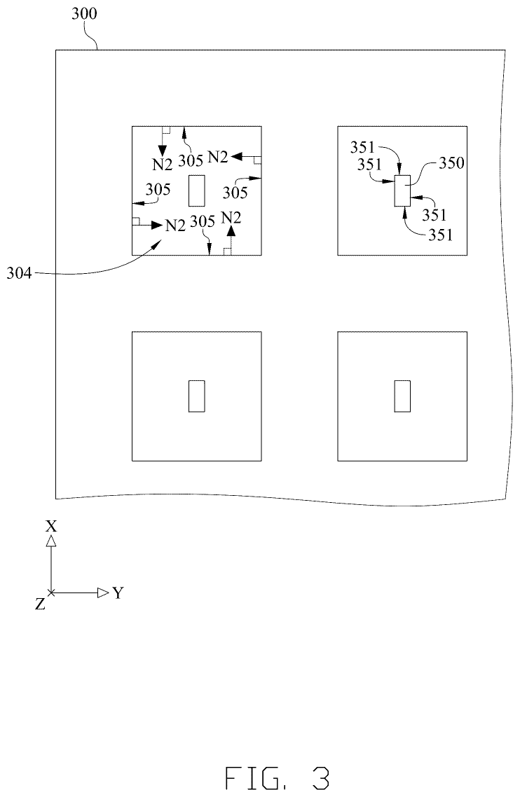

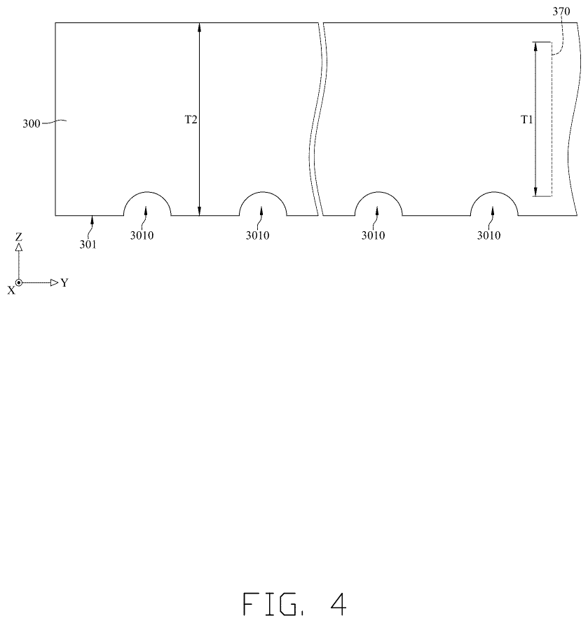

Referring to FIGS. 1 to 4, wherein, FIG. 1 is a side schematic diagram of a display panel and a backlight module according to a first embodiment of the present application, FIG. 2 is a top schematic diagram of a light guide plate, a shading structure and a light source of the backlight module in FIG. 1, FIG. 3 is a partial enlarged view of the light guide plate and the light source in FIG. 2, and FIG. 4 is a partial enlarged view of a side schematic diagram of the light guide plate of the backlight module in FIG. 1 from another viewing angle.

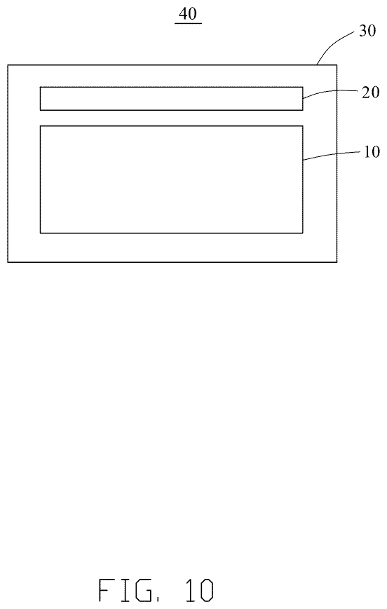

In at least one embodiment, referring to FIGS. 1 and 2, the backlight module 10 includes a substrate 100, a reflective layer 200, a light guide plate 300, a plurality of light sources 350, a plurality of first light shielding structures 360, a plurality of second light shielding structures 370, a top diffusing plate 400, a diffusion film 500, and prism sheets 600, 650. The backlight module 10 is used to transmit light to the display panel 20. Referring to FIG. 10, the backlight module 10 and the display panel 20 can be accommodated in a housing 30 of the display 40.

The substrate 100 may be, for example, a circuit board. The reflective layer 200 is arranged on the substrate 100.

The light guide plate 300 is arranged on the substrate 100. Specifically, the reflective layer 200 is arranged between the light guide plate 300 and the substrate 100, that is, the light guide plate 300 is arranged on the substrate 10 through the reflective layer 200. The light guide plate 300 includes a bottom surface 301, a top surface 302, and a plurality of receiving recesses 303. The bottom surface 301 and the top surface 302 are facing away from each other. The bottom surface 301 is closer to the substrate 100 than the top surface 302, that is, the bottom surface 301 is located between the top surface 302 and the substrate 100. The plurality of receiving recesses 303 are recessed inward from the bottom surface 301 and are arranged in a plurality of rows along an arrangement direction A1 (parallel to an X-axis direction). The arrangement direction Al is not parallel to a normal direction N1 (parallel to a Z-axis direction) of the bottom surface 301, such as being perpendicular to each other. Each row of the plurality of receiving recesses 303 includes at least two receiving recesses 303. In this embodiment, the receiving recesses 303 in each row may be aligned with each other and the plurality of receiving recesses 303 may be arranged in a 3 -by-13 array, that is, the receiving recesses 303 in this embodiment can be understood as being arranged in 3 rows along the arrangement direction A1, and each row of the receiving recesses 303 includes 13 receiving recesses 303, or can be understood as being arranged in 13 rows along the arrangement direction A2 (perpendicular to the arrangement direction Al and parallel to the Y-axis direction), and each row of the receiving recesses 303 includes 3 receiving recesses 303.

Referring to FIG. 3, each of the plurality of receiving recesses 303 includes a groove bottom surface 304 and a plurality of light incident surfaces 305 connected to the groove bottom surface 304. The plurality of light incident surfaces 305 are adjacent to each other and are not parallel to each other. Moreover, a normal direction N2 of each of the plurality of light incident surfaces 305 is not parallel to the normal direction N1 of the bottom surface 301, such as being perpendicular to each other. In this embodiment, each of the plurality of receiving recesses 303 may be, for example, rectangular, therefore, each of the plurality of receiving recesses 303 includes four light incident surfaces 305. The normal directions N2 of two of the four light incident surfaces 305 are opposite to each other and parallel to the X-axis direction. The normal directions N2 of the other two light incident surfaces 305 are opposite to each other and parallel to the Y-axis direction.

The plurality of light sources 350 are electrically connected to the substrate 100 and are respectively arranged in the plurality of receiving recesses 303 of the light guide plate 300. That is, in this embodiment, one of the plurality of receiving recesses 303 may accommodate one of the plurality of light sources 350. Each of the plurality of light sources 350 is used to emit light toward at least one of the plurality of light incident surfaces 305 of one of the plurality of receiving recesses 303. In detail, in this embodiment, the plurality of light sources 350, for example, each of the plurality of light sources 350 may include a plurality of light-emitting surfaces 351, and the plurality of light-emitting surfaces 351 of each of the plurality of light source 350 respectively face the plurality of light incident surfaces 305 in a corresponding receiving recess 303, that is, in this embodiment, each of the plurality of light sources 350 emits light toward all the plurality of light incident surfaces 305 of the receiving recess 303 that receives it. In addition, the plurality of light sources 350 may be, for example, light-emitting diodes (LEDs), and may have any color composition such as blue light, blue-green light, ultraviolet light, etc.

It should be noted that in other embodiments, a plurality of the plurality of light sources may be accommodated in one of the plurality of receiving recesses.

In addition, in this embodiment, as shown in FIG. 4, the bottom surface 301 of the light guide plate 300 may include, for example, a plurality of microstructures 3010. The plurality of microstructures 3010 may be, for example, grooves, and are used to guide the light emitted by the light source 350 to a desired direction. In other embodiments, the plurality of microstructures 3010 may be omitted.

Referring to FIGS. 2 and 4, the plurality of first light shielding structures 360 are arranged in parallel with each other in the light guide plate 300, and the plurality of second light shielding structures 370 are arranged in parallel with each other in the light guide plate 300. The plurality of first light shielding structures 360 and the plurality of second light shielding structures 370 are arranged between the bottom surface 301 and the top surface 302, and are formed in the light guide plate 300 by any suitable method such as laser processing, mechanical processing, transfer printing, or embossing, etc. An extension direction E1 (parallel to a Y-axis direction) of each of the plurality of first light shielding structures 360 and an extension direction E2 (parallel to the X-axis direction) of each of the plurality of second light shielding structures 370 are not parallel (such as perpendicular to each other), and each of the plurality of first light shielding structures 360 and each of the plurality of second light shielding structures 370 intersect with each other, so that the plurality of first light shielding structures 360 and the plurality of second light shielding structures 370 separate the plurality of light sources 350 from each other. In this way, the plurality of first light shielding structures 360 and the plurality of second light shielding structures 370 can prevent the light emitted by different light sources 350 from mixing with each other, thereby improving the effect of local dimming.

In this embodiment, a light transmittance of each of the plurality of first light shielding structures 360 and the plurality of second light shielding structures 370 may be less than 10%. In addition, in this embodiment, referring to FIG. 4, a thickness T1 of each of the plurality of first light shielding structures 360 and the plurality of second light shielding structures 370 may be greater than or equal to 10% of a thickness T2 of the light guide plate 300 and less than or equal to 90% of the thickness T2 of the light guide plate 300, such as 80%. Through the above light transmittance design and/or the above thickness design, the plurality of first light shielding structures 360 and the plurality of second light shielding structures 370 can further prevent the light emitted from different light sources 350 from mixing with each other. It should be noted that the effect of local dimming can also be improved by controlling the light emitted from different light-emitting surfaces 351 by the light source 350, in this case, the backlight module may not need to include the plurality of first light shielding structures 360 and the plurality of second light shielding structures 370. In addition, the thickness T2 of the light guide plate 300 may be greater than or equal to 0.1 mm and less than or equal to 2 mm.

The top diffusing plate 400 is arranged on a side of the light guide plate 300 facing away from the substrate 100, in other words, the top diffusing plate 400 is arranged on the top surface 302 of the light guide plate 300. In addition, the top diffusing plate 400 is in contact with or adjacent to the top surface 302 of the light guide plate 300, so that an optical distance (OD) of the backlight module 10 will be reduced as much as possible (i.e., a distance between the light source 350 and the top diffusing plate r 400 will be reduced as much as possible), which facilitates the thinning of the display using the backlight module 10.

The diffusion film 500 is arranged on the top diffusing plate 400. In this embodiment, the diffusion film 500 is arranged on a side of the top diffusing plate 400 facing away from the substrate 100. The prism sheet 600 is arranged on the diffusion film 500, and the prism sheet 650 is arranged on the prism sheet 600. It should be noted that in this embodiment, the backlight module 10 includes a reflective layer 200, a top diffusing plate 400, a diffusion film 500, and the prism sheets 600, 650 according to actual needs. In other embodiments, the backlight module 10 may not necessarily include the reflective layer 200, the top diffusing plate 400, the diffusion film 500, and the prism sheets 600, 650.

Other embodiments will be listed below for illustration. It must be noted that the following embodiments use the component numbers and some contents of the previous embodiments, wherein the same numbers are used to represent the same or similar components, and the description of the same technical contents is omitted. The description of the omitted parts can be referred to the previous embodiments, and the following embodiments will not be repeated.

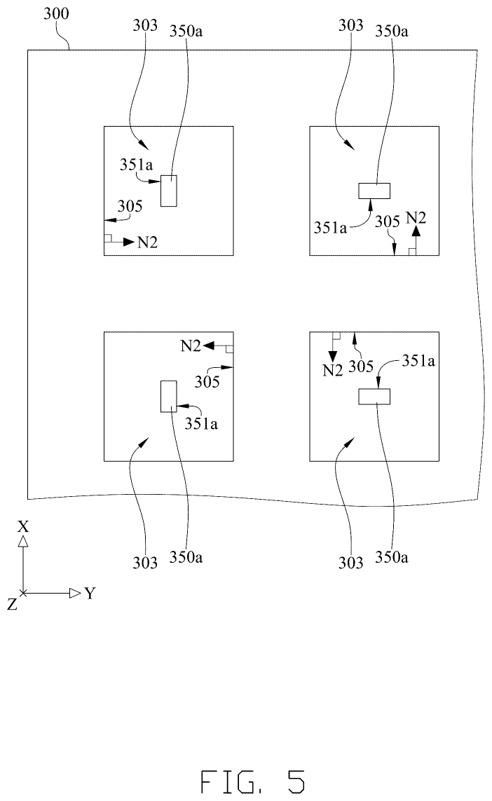

The present application is not limited to the configuration of the light emitting surface of the light source. Referring to FIG. 5, FIG. 5 is a partial enlarged view of a top schematic diagram of a light guide plate and a light source according to a second embodiment of the present application. In this embodiment, each of the plurality of light sources 350a includes only one light emitting surface 351a. The light emitting surface 351a of each of the plurality of light source 350a faces one of the plurality of light incident surfaces 305 in the corresponding accommodating recess 303. In addition, the normal directions N2 of the light incident surfaces 305 facing the light emitting surfaces 351a of the light sources 350a adjacent to each other are different from each other. It should be noted that the plurality of light source 350a of this embodiment can replace the plurality of light source 350 of the first embodiment and be included in the backlight module 10.

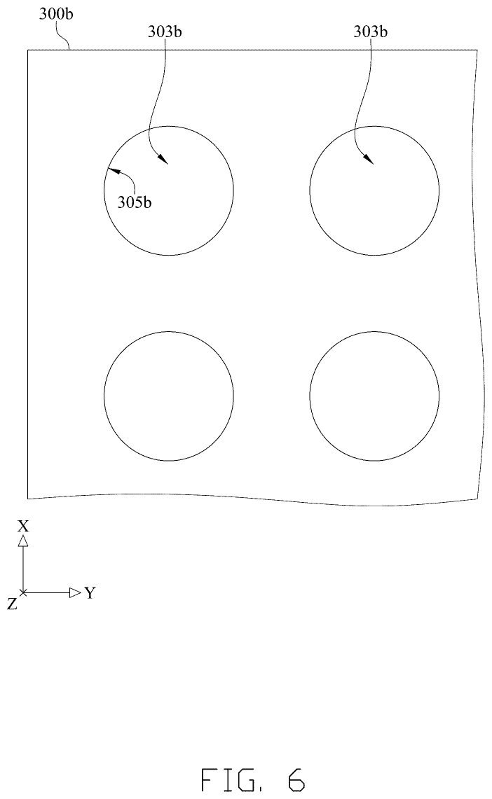

The present application is not limited to a shape of each of the plurality of receiving recesses. Referring to FIG. 6, FIG. 6 is a partial enlarged view of a top schematic diagram of a light guide plate according to a third embodiment of the present application. In this embodiment, for example, each of the plurality of receiving recesses 303b of the light guide plate 300b may be circular and may have a light incident surface 305b in the shape of a circular ring.

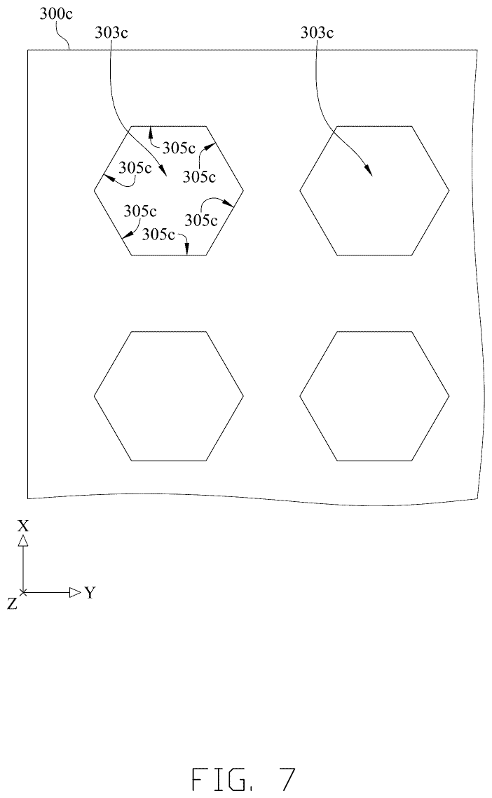

In at least one embodiment, referring to FIG. 7, FIG. 7 is a partial enlarged view of a top schematic diagram of a light guide plate according to a fourth embodiment of the present application. In this embodiment, for example, each of the plurality of receiving recesses 303c of the light guide plate 300c may be hexagonal and may have six light incident surfaces 305c.

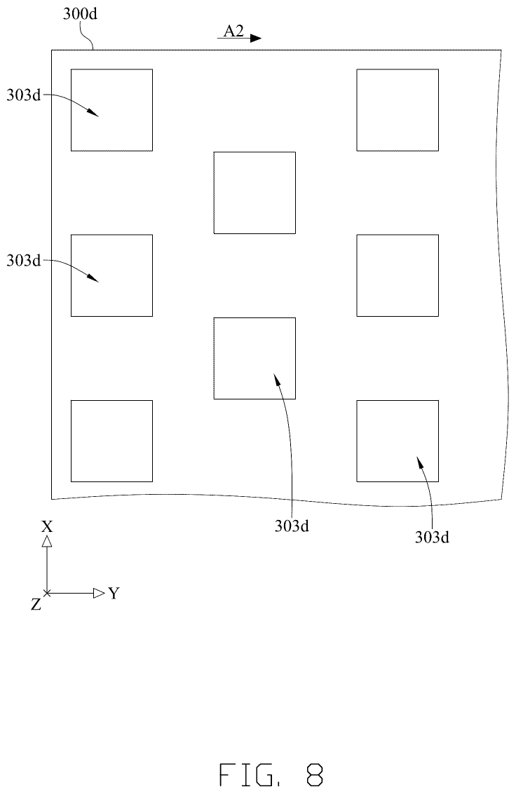

The present application is not limited to the arrangement of the accommodating recess. Referring to FIG. 8, FIG. 8 is a partial enlarged view of a top schematic diagram of a light guide plate according to a fifth embodiment of the present application. In this embodiment, the plurality of receiving recesses 303d of the light guide plate 300d may be arranged in multiple rows along the arrangement direction A2, and receiving recesses 303d in two adjacent rows of the plurality of receiving recesses 303d may be offset from each other.

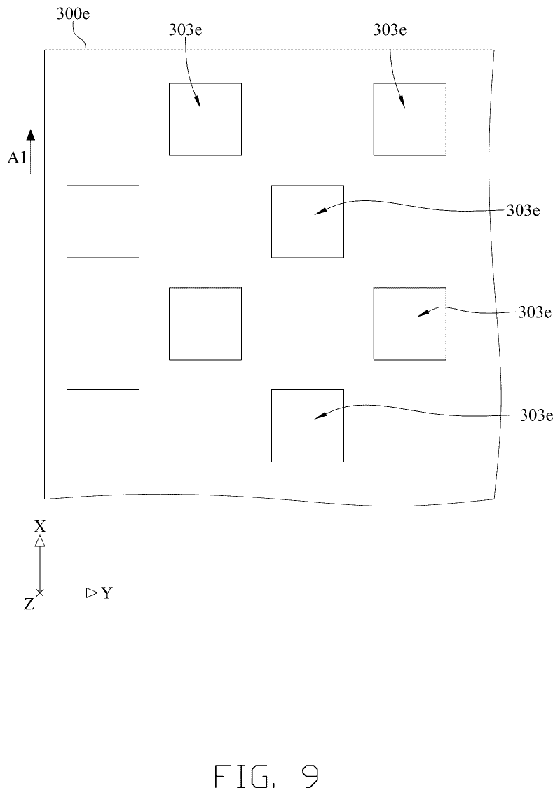

In at least one embodiment, referring to FIG. 9, FIG. 9 is a partial enlarged view of a top schematic diagram of a light guide plate according to a sixth embodiment of the present application. In this embodiment, the plurality of receiving recesses 303e of the light guide plate 300e may be arranged in multiple rows along the arrangement direction A1, and receiving recesses 303E in two adjacent rows of the plurality of receiving recesses 303E may be offset from each other.

It should be noted that the light guide plate 300b of the third embodiment, the light guide plate 300c of the fourth embodiment, the light guide plate 300d of the fifth embodiment, or the light guide plate 300e of the sixth embodiment may be included in the backlight module 10 instead of the light guide plate 300 of the first embodiment.

According to the backlight module arranged in the above embodiments, the receiving recesses are recessed inward from the bottom surface of the light guide plate, and the light sources are arranged in the receiving recesses and are used to emit light toward at least one light incident surface of one of the receiving recesses. Therefore, the lens in the general direct-type backlight module can be omitted, and the light guide plate can be used as the light guide medium of the light source to achieve the thinning of the display using the backlight module. In addition, even if the light sources arranged in the receiving recesses do not cover the entire backlight module, it can also have an excellent local backlight adjustment effect. In this way, the backlight module can take into account thinness, low cost and excellent local backlight adjustment effect.

The above embodiments are only used to illustrate the technical solution of the present application rather than to limit it. Although the present application has been described in detail with reference to the above preferred embodiments, a person skilled in the art should understand that the technical solution of the present application can be modified or replaced by equivalents without departing from the spirit and scope of the technical solution of the present application.

1. A backlight module comprising:
a substrate;
a light guide plate arranged on the substrate and comprising a bottom surface, a top surface, and a plurality of receiving recesses, wherein the bottom surface and the top surface are facing away from each other, the bottom surface is closer to the substrate than to the top surface, the plurality of receiving recesses are recessed inward from the bottom surface, each of the plurality of receiving recesses comprises a groove bottom surface and at least one light incident surface connected to the groove bottom surface, a normal direction of each of the at least one light incident surface is not parallel to a normal direction of the bottom surface;
a plurality of light sources electrically connected to the substrate and correspondingly arranged in the plurality of receiving recesses of the light guide plate, wherein each of the plurality of light sources is configured to emit light toward the at least one light incident surface of a corresponding receiving recess of the plurality of receiving recesses; and
each of the plurality of light sources is arranged in one of the plurality of receiving recesses;
a plurality of first light shielding structures and a plurality of second light shielding structures, wherein the plurality of first light shielding structures are arranged in parallel with each other in the light guide plate, and the plurality of second light shielding structures are arranged in parallel with each other in the light guide plate, an extension direction of each of the plurality of first light shielding structures and an extension direction of each of the plurality of second light shielding structures are not parallel, and each of the plurality of first light shielding structures and each of the plurality of second light shielding structures intersect with each other to separate any two adjacent ones of the plurality of light sources from each other;
a light transmittance of each of the plurality of first light shielding structures is less than 10%, and a light transmittance of each of the plurality of second light shielding structures is less than 10%.

2. The backlight module of claim 1, wherein the plurality of receiving recesses is arranged in a plurality of rows along an arrangement direction, and receiving recesses in each of the plurality of rows of the plurality of receiving recesses are aligned with each other and arranged in an array.

3. The backlight module of claim 1, wherein the plurality of receiving recesses is arranged in a plurality of rows along an arrangement direction, and receiving recesses in two adjacent rows of the plurality of rows of the plurality of receiving recesses are offset from each other.

4. (canceled)

5. The backlight module of claim 1, wherein each of the plurality of light sources comprises a light-emitting surface, each of the plurality of receiving recesses comprises a plurality of light incident surfaces, the plurality of light incident surfaces is adjacent to each other and at least two of the plurality of light sources are not parallel to each other, the light-emitting surface of each of the plurality of light sources faces one of the plurality of light incident surfaces of the corresponding receiving recess.

6. The backlight of claim 1, wherein each of the plurality of light sources comprises a plurality of light-emitting surfaces, each of the plurality of receiving recesses comprises a plurality of light incident surfaces, the plurality of light incident surfaces is adjacent to each other and at least two of the plurality of light sources are not parallel to each other, each of the plurality of light-emitting surface of each of the plurality of light sources faces one of the plurality of light incident surfaces of the corresponding receiving recess.

7. (canceled)

8. The backlight module of claim 1, further comprising a top diffusing plate, wherein the top diffusing plate is arranged on a side of the light guide plate facing away from the substrate.

9. The backlight module of claim 8, wherein the top diffusing plate is in contact with or adjacent to the light guide plate.

10. The backlight module of claim 1, wherein the bottom surface of the light guide plate comprises a plurality of microstructures.

11. An electronic device comprising:
a housing; and
a backlight module accommodated in the housing and comprising:
a substrate;
a light guide plate arranged on the substrate and comprising a bottom surface, a top surface, and a plurality of receiving recesses, wherein the bottom surface and the top surface are facing away from each other, the bottom surface is closer to the substrate than to the top surface, the plurality of receiving recesses are recessed inward from the bottom surface, each of the plurality of receiving recesses comprises a groove bottom surface and at least one light incident surface connected to the groove bottom surface, a normal direction of each of the at least one light incident surface is not parallel to a normal direction of the bottom surface;
a plurality of light sources electrically connected to the substrate and correspondingly arranged in the plurality of receiving recesses of the light guide plate, wherein each of the plurality of light sources is configured to emit light toward the at least one light incident surface of a corresponding receiving recess of the plurality of receiving recesses; and
each of the plurality of light sources is arranged in one of the plurality of receiving recesses;
a plurality of first light shielding structures and a plurality of second light shielding structures, wherein the plurality of first light shielding structures are arranged in parallel with each other in the light guide plate, and the plurality of second light shielding structures are arranged in parallel with each other in the light guide plate, an extension direction of each of the plurality of first light shielding structures and an extension direction of each of the plurality of second light shielding structures are not parallel, and each of the plurality of first light shielding structures and each of the plurality of second light shielding structures intersect with each other to separate any two adjacent ones of the plurality of light sources from each other;
a light transmittance of each of the plurality of first light shielding structures is less than 10%, and a light transmittance of each of the plurality of second light shielding structures is less than 10%.

12. The electronic device of claim 11, wherein the plurality of receiving recesses is arranged in a plurality of rows along an arrangement direction, and receiving recesses in each of the plurality of rows of the plurality of receiving recesses are aligned with each other and arranged in an array.

13. The electronic device of claim 11, wherein the plurality of receiving recesses is arranged in a plurality of rows along an arrangement direction, and receiving recesses in two adjacent rows of the plurality of rows of the plurality of receiving recesses are offset from each other.

14. (canceled)

15. The electronic device of claim 11, wherein each of the plurality of light sources comprises a light-emitting surface, each of the plurality of receiving recesses comprises a plurality of light incident surfaces, the plurality of light incident surfaces are adjacent to each other and at least two of the plurality of light sources are not parallel to each other, the light-emitting surface of each of the plurality of light sources faces one of the plurality of light incident surfaces of the corresponding receiving recess.

16. The electronic device of claim 11, wherein each of the plurality of light sources comprises a plurality of light-emitting surfaces, the, each of the plurality of receiving recesses comprises a plurality of light incident surfaces, the plurality of light incident surfaces is adjacent to each other and at least two of the plurality of light sources are not parallel to each other, each of the plurality of light-emitting surface of each of the plurality of light sources faces one of the plurality of light incident surfaces of the corresponding receiving recess.

17. (canceled)

18. The electronic device of claim 11, further comprising a top diffusing plate, wherein the top diffusing plate is arranged on a side of the light guide plate facing away from the substrate.

19. The electronic device of claim 18, wherein the top diffusing plate is in contact with or adjacent to the light guide plate.

20. The electronic device of claim 11, wherein the bottom surface of the light guide plate comprises a plurality of microstructures.
